(19) United States
(12) Patent Application Publication
(10) Pub. No.: US 2018/0046628 A1
(43) Pub. Date: Feb. 15, 2018

(54) RANKING SOCIAL MEDIA CONTENT

(71) Applicant: FUJITSU LIMITED, Kawasaki-shi (JP)

(72) Inventors: Jun WANG, San Jose, CA (US); Kanji UCHINO, Santa Clara, CA (US)

(73) Assignee: FUJITSU LIMITED, Kawasaki-shi (JP)

(21) Appl. No.: 15/236,183

(22) Filed: Aug. 12, 2016

(51) Int. Cl. G06F 17/30; G06Q 50/00

(52) U.S. Cl. CPC G06F 17/3053; G06Q 50/01

(57) ABSTRACT

A system for ranking social media content may be provided. The system may include one or more processors. The one or more processors may be configured to extract author profile data from one or more authors of domain-specific content and identify social media content based on the author profile data. The one or more processors may further be configured to rank the social media content based on at least one of user interest data, user preference data, statistics for the social media content, author data, statistics for a social media account including the social media content, and content age data.

### FIELD

The embodiments discussed herein are related to ranking social media content.

### BACKGROUND

With the advent of computer networks, such as the Internet, and the growth of technology, more and more content is available to more and more people. For example, many leading researchers are sharing content and exchanging ideas timely using social media.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a system may include one or more processors configured to extract author data from one or more authors of domain-specific content and identify social media content based on the author data. For example, the domain-specific content may include publications, and the identified social media content may be owned by the one or more authors. The one or more processors may further be configured to rank the social media content based on at least one of user interest data, user preference data, statistics for the social media content (e.g., social media items associated with the social media content), author data, statistics for a social media account (e.g., posted associated items), and content age data.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example system configured to rank social media content;

FIG. 2 is a diagram of an example flow that may be used to extract and rank social media content;

FIG. 3 is a flowchart of an example method of content identification and extraction;

FIG. 4 depicts example social media items and associated fetched content;

FIG. 5 is a diagram of an example flow that may be used to rank social media content;

FIGS. 6A and 6B depict a diagram of an example flow that may be used for a topic model analysis;

FIGS. 7A and 7B depict a diagram of an example flow that may be used to generate a user profile;

FIG. 8 is a flowchart of an example method of measuring social media content freshness; and

FIG. 9 is an example system that may identify, extract and rank social media content.

### DESCRIPTION OF EMBODIMENTS

Some embodiments described herein relate to extracting, and ranking content fetched from social media (e.g., content that is created, shared and/or commented on via social media) based not only on social media account related information but also corresponding real author information. Various embodiments may provide users with an efficient way of acquiring relevant and professional domain-specific knowledge.

The current fast-pace of technology, research, and general knowledge creation has resulted in previous and current methods of knowledge dissemination is inadequate for providing up-to-date knowledge and information on recent developments. Further, knowledge is no longer generated by a few select individuals in select regions. Rather, researchers, professors, experts, and others with knowledge of a given topic, referred to in this disclosure as knowledgeable people, are located around the world and are constantly generating and sharing new ideas.

As a result of the Internet, however, this vast wealth of newly created knowledge from around the world is being shared worldwide in a continuous manner. In some circumstances, this vast knowledge is being shared through social media. For example, knowledgeable people may share knowledge recently acquired through blogs, micro-blogs, and other social media.

Knowing that current information is being shared on social media does not result in the current information being readily accessible or that an individual could realistically access the information. In some fields, there may be thousands, tens of thousands, or hundreds of thousands of knowledgeable people. There is no database that includes the names of knowledgeable people from a specific field. However, even if a database included the names, the time spent for a person to determine if the knowledgeable people have social media accounts would be unreasonable for anyone to consider.

In short, due to the rise of computers and the Internet, mass amounts of information (e.g., content) is available, but there is no realistic way for a person to reasonably access the information. Some embodiments described herein relate to extracting and ranking information that may help people to access the information that was either previously unavailable or not reasonably obtainable by a human or even a group of humans without the aid of technology.

Various embodiments include determining knowledgeable people by determining authors of publications and lectures. Metadata about the multiple authors may be extracted from the publications and lectures. The author metadata may be used to search social media accounts to determine the social media accounts of the authors. For example, in some embodiments, the author metadata may include information about the author's name, a profile of an author (e.g., a description of the author), and co-authors. The information from the social media accounts may be compared to the author metadata to match the authors to the social media accounts. In some embodiments, topic of information provided on the social media accounts may be considered. Thus, if an author has a social media account, but does not share knowledge related to the topic for which the author has published, the social media account may not be considered.

After identifying the social media accounts, information (e.g., content) on the identified social media accounts may be collected, organized, ranked, and presented. For example, the information may be organized based on topics such that a person interested in a selected topic could be presented with the current knowledge from multiple different knowledgeable people with current updates. In this manner, new information from a number of sources that could not reasonably be identified or managed by a person may be accessed and shared. Further, information may be ranked based on, for example, social media account data, corresponding author data, and/or user data (e.g., user interests and/or user preferences). Ranking social media content may refine and reorganize information and may provide an efficient way for users to acquire knowledge. Thus, various embodiments of the present disclosure provide a technical solution to a problem that arises from technology that could not reasonably be performed by a person.

Embodiments of the present disclosure are explained with reference to the accompanying drawings.

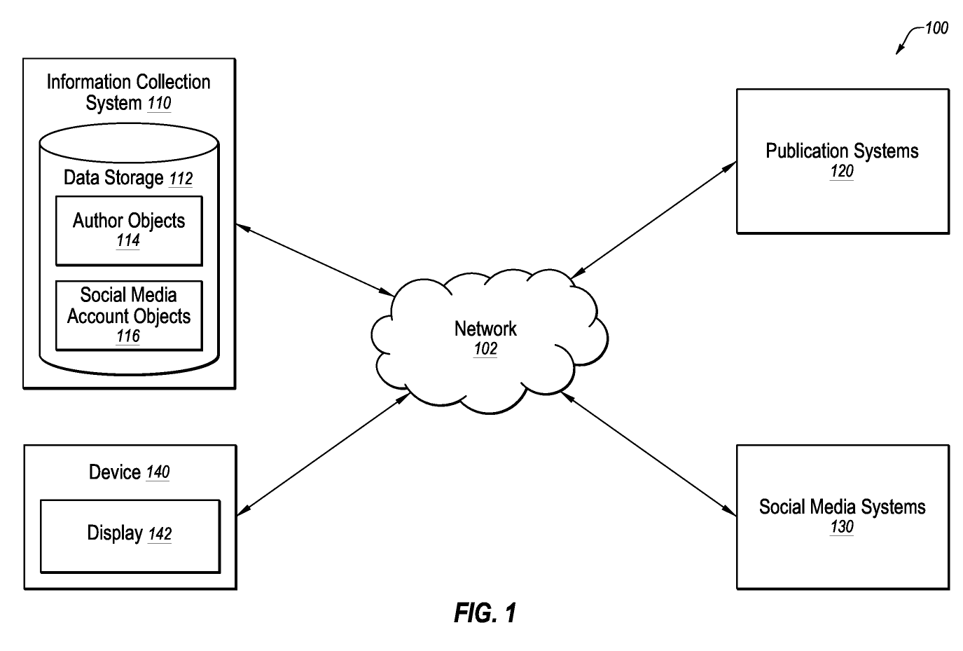

FIG. 1 is a diagram representing an example system 100, arranged in accordance with at least one embodiment described in the disclosure. System 100 may include a network 102, an information collection system 110, publication systems 120, social media systems 130, and a device 140.

Network 102 may be configured to communicatively couple information collection system 110, publication systems 120, social media systems 130, and device 140. In some embodiments, network 102 may be any network or configuration of networks configured to send and receive communications between devices. In some embodiments, network 102 may include a conventional type network, a wired or wireless network, and may have numerous different configurations. Furthermore, network 102 may include a local area network (LAN), a wide area network (WAN) (e.g., the Internet), or other interconnected data paths across which multiple devices and/or entities may communicate. In some embodiments, network 102 may include a peer-to-peer network. Network 102 may also be coupled to or may include portions of a telecommunications network for sending data in a variety of different communication protocols. In some embodiments, network 102 may include Bluetooth® communication networks or cellular communication networks for sending and receiving communications and/or data including via short message service (SMS), multimedia messaging service (MMS), hypertext transfer protocol (HTTP), direct data connection, wireless application protocol (WAP), e-mail, etc. Network 102 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, network 102 may include one or more IEEE 802.11 wireless networks.

In some embodiments, any one of information collection system 110, publication systems 120, and social media systems 130, may include any configuration of hardware, such as servers and databases that are networked together and configured to perform a task. For example, information collection system 110, publication systems 120, and social media systems 130 may each include multiple computing systems, such as multiple servers, that are networked together and configured to perform operations as described in this disclosure. In some embodiments, any one of information collection system 110, publication systems 120, and social media systems 130 may include computer-readable-instructions that are configured to be executed by one or more devices to perform operations described in this disclosure.

Information collection system 110 may include a data storage 112. Data storage 112 may be a database in information collection system 110 with a structure based on data objects. For example, data storage 112 may include multiple data objects with different fields. In some embodiments, data storage 112 may include author objects 114 and social media account objects 116.

In general, information collection system 110 may be configured to obtain author information of publications, such as articles, lectures, and other publications from publication systems 120. Using the author information, information collection system 110 may determine social media accounts associated with the authors and pull information from the social media accounts from social media systems 130. Information collection system 110 may organize (e.g., according to rank) and provide the information from the social media accounts to device 140 such that the information may be presented (e.g., to a user) on a display 142 of device 140.

Publication systems 120 may include multiple systems that host articles, publications, journals, lectures, and other digital documents. The multiple systems of publication systems 120 may not be related other than they all host media that provides information. For example, one system of the publication systems 120 may include a university website that host lectures and papers of a professor at the university. Another of publication systems 120 may be a website that host articles published in journals. In these and other embodiments, publication systems 120 may not share a website, a server, a hosting domain, or an owner.

In some embodiments, information collection system 110 may access one or more of publication systems 120 to obtain digital documents from publication systems 120. Using the digital documents, information collection system 110 may obtain information about the authors of the digital documents and topics of the digital documents. In some embodiments, for each author of a digital document, information collection system 110 may create an author object 114 in data storage 112. In created author object 114, information collection system 110 may store information about the author obtained from the digital document. The information may include a name, profile (e.g., description of the author), an image, and co-authors of the digital document. Information collection system 110 may also determine topics of the digital document. The topics of the digital document may be stored in author object 114.

In some embodiments, multiple digital documents from publication systems 120 may include the same author. In these and other embodiments, author object 114 for the author may be updated and/or supplemented with information from the other digital documents. For example, the topics from the other digital documents may be stored in author object 114. In some embodiments, the topics of all of the digital documents of an author obtained by information collection system 110 may be stored in author object 114.

After creating author objects 114, information collection system 110 may be configured to determine social media accounts for each of the authors in author objects 114. Information collection system 110 may determine social media accounts by accessing social media systems 130.

In some embodiments, each of social media systems 130 may be a system configured to host a different social media. For example, one of social media systems 130 may be a microblog social media system. Another of social media systems 130 may be a blogging social media system. Another of social media systems 130 may be a social network or other type of social media system.

Information collection system 110 may request each of social media systems 130 to search its respective social media accounts for the names of each author in author objects 114. For example, information collection system 110 may include thousands, tens of thousands, or hundreds of thousand author objects 114, where each author objects 114 includes the name of one author. In this example, there may be four social media systems 130 in which authors may share information. The number of social media systems 130 may be more of less than four. In these and other embodiments, information collection system 110 may request a search be performed in each of the four social media systems 130 using the name of the author associated with each author objects 114. Thus, if there were four social media systems 130 and 100,000 authors, then information collection system 110 would request 400,000 searches. Social media systems 130 may provide the results of the searches to information collection system 110. In these and other embodiments, the results of the searches may be links and/or network addresses of social media accounts with an owner that has a name that at least partially matches the names of the authors of author objects 114.

Using the links and/or network addresses of the social media accounts from the search, information collection system 110 may request the social media accounts. The information collection system 110 may also create a social media account object 116 for each of the social media accounts. To create social media account objects 116, information collection system 110 may pull information from the social media accounts and store the information in social media account objects 116. Social media account objects 116 may include information about the person associated with the social media account, such as a name, profile data (e.g., description of the person), image, and social media contacts. Information collection system 110 may also obtain topics of the posts in the social media accounts which may also be stored in social media account objects 116.

Information collection system 110 may compare the information from author objects 114 with the information from social media account objects 116 to determine the social media accounts associated with the authors in author objects 114. For example, for a given author object 114, the search of social media systems 130 may result in twenty-five accounts. Social media account objects 116 of the twenty-five accounts may be compared to the given author object 114 to determine which of the twenty-five accounts is associated with the author of the given author object 114. In some embodiments, an author may be associated with a social media account when the author is the owner of the social media account.

After matching social media accounts with authors from the digital documents from publication systems 120, information collection system 110 may obtain information (e.g., content) from the matching social media accounts. In these and other embodiments, information collection system 110 may request the social media accounts and parse the social media accounts to obtain the information from the social media accounts. Information collection system 110 may collate the information from the social media accounts and organize the information (e.g., based on rank) to provide the information to users of information collection system 110. For example, information collection system 110 may provide the information to device 140.

Device 140 may be associated with a user of information collection system 110. In these and other embodiments, device 140 may be any type of computing system. For example, device 140 may be a desktop computer, tablet, mobile phone, smart phone, or some other computing system. Device 140 may include an operating system that may support a web browser. Through the web browser, device 140 may request webpages from information collection system 110 that include information collected by information collection system 110 from the social media accounts of social media systems 130. The requested webpages may be displayed on display 142 of device 140 for presentation to a user of device 140.

Modifications, additions, or omissions may be made to system 100 without departing from the scope of the present disclosure. For example, system 100 may include multiple other devices that obtain information from information collection system 110. Alternately or additionally, system 100 may include one social media system.

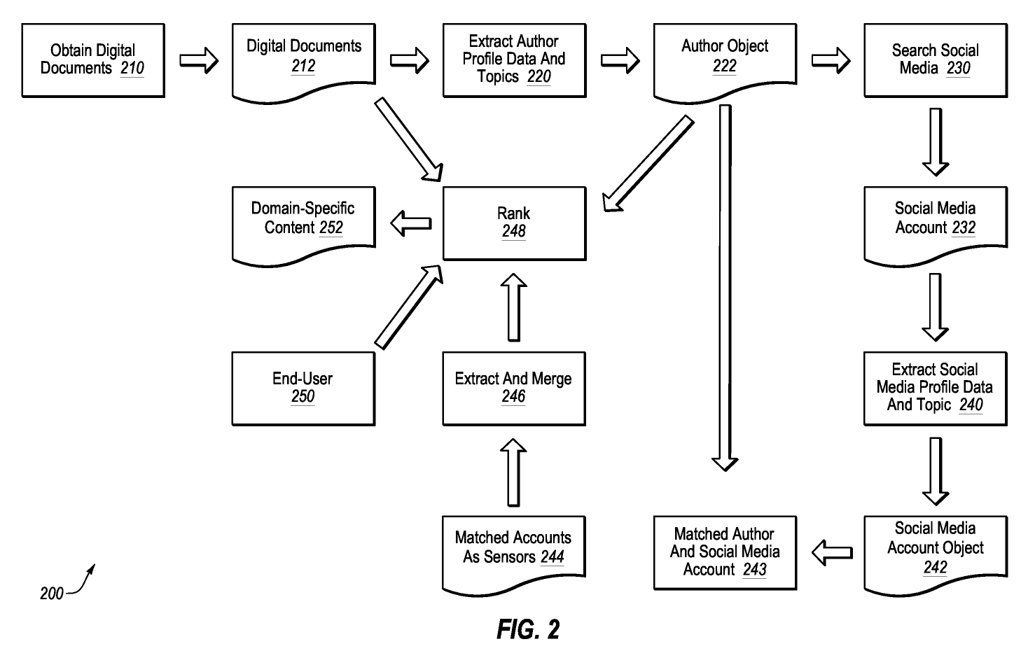

FIG. 2 is a diagram of an example flow 200 that may be used to extract and rank social media content, according to at least one embodiment described herein. In some embodiments, the flow 200 may be configured to illustrate a process to extract, and rank content from social media accounts. In these and other embodiments, a portion of the flow 200 may be an example of the operation of system 100 of FIG. 1.

The flow 200 may begin at block 210, wherein digital documents 212 may be obtained. Digital documents 212 may be obtained from one or more sources, such as websites and other sources. Digital documents 212 may be a publication, lecture, article, or other document. In some embodiments, digital documents 212 may be a recent document, such as document released within a particular period, such as within the last week, month, or several months.

At block 220, author profile data and topics of all or some of digital documents 212 may be extracted using methods such as topic model analysis. Author profile data about an author in one or more of digital documents 212 may be extracted and stored in an author object 222. In some embodiments, the author profile data may include a full name of the author, an affiliation of the author, title of the author, co-authors, a document image of the author, and an expertise or interest description of the author. The affiliation of the author may relate to the business, university, or other entity, with which the author affiliates. The title of the author may include a rank or position of the author. For example, the author may have the title of doctor, research manager, senior researcher, professor, lecturer etc. To extract the author profile data, digital documents 212 may be parsed and searched for text associated with the author profile data.

In some embodiments, a topic model analysis may be performed on digital documents 212. In some embodiments, the topic model analysis may include a number of topics that may be determined and digital documents 212 may be analyzed to determine which of the topics are in digital documents 212. In these and other embodiments, the topic model analysis may output a term distribution from digital documents 212 for each of the topics. Alternately or additionally, a topic distribution for each digital document 212 may be determined. Thus, it may be determined the topics for each of digital documents 212. Note that in some embodiments, one or more of digital documents 212 may include multiple topics. In some embodiments, the topics for each digital document 212 may be stored in author object 222.

At block 230, social media may be searched for the author from author object 222. In some embodiments, social media may be searched using the full name of the author. The search for the author may result in a social media account 232 that may be owned, operated by, or associated with the author of digital document 212.

At block 240, social media profile data may be extracted from social media account 232. The social media profile data may be similar to the author data. For example, the social media profile data may include information about the person that owns, operates, or is associated with the social media account. The person that owns, operates, or is associated with the social media account may be referred to as a social media account owner. The social media profile data may include a name, affiliations, locations, titles, expertise, a social media image, or interest description, and other information about the social media account owner. In some embodiments, the social profile data may be collected by parsing and analyzing text from the social media account that is not a posting on the social media account, such as a biography, profile, or other information about the person that owns the social media account.

In some embodiments, a number of social media accounts connected to social media account 232 may be determined. Alternately or additionally, the social media account owners of the social media accounts connected to social media account 232 may be identified. In some embodiments, a number of social media accounts mentioned by social media account 232 may be determined. Alternately or additionally, the social media account owners of the social media accounts mentioned by social media account 232 may be identified. The information about the number of owners connected and/or mentioned in social media account 232 may be part of social media interaction data.

In some embodiments, the expertise of the social media account owners for one or more of the social media accounts mentioned or connected to social media account 232 may be determined. In these or other embodiments, the mentioned or connected social media accounts may be accessed. The expertise of the mentioned or connected social media accounts owners may be determined. In some embodiments, the expertise may be determined based on a description in a profile of the social media accounts owners. Alternately or additionally, the expertise may be determined based on the topics of the postings of the mentioned or connected social media accounts.

In some embodiments, topics of the postings on social media account 232 may also be determined. To determine the topics of the postings, the postings shorter than a threshold number of words may be removed. The threshold number of words may depend on the form of the social media. For example, if the social media is a microblog, the threshold number may be smaller than the threshold number for a blog.

In addition to the postings on social media account 232, content linked by the postings on social media account 232 may be used to determine the topics or topic of social media account 232. In these and other embodiments, the links within the postings of social media account 232 may be accessed and the content collected. In particular, links within postings of social media accounts 232 that are microblogs may be accessed and content collected. The collected content and the postings may be aggregated. A topic model analysis may be applied to determine topic distributions of the aggregated content. Using the topic model, topic distribution of social media account 232 may be determined. In some embodiments, the authors of the content collected from the links in the postings of social media account 232 may also be collected. The social media profile data, social media interaction data, and topics may be stored as social media account object 242.

At block 243, social media account object 242 associated with the social media account 232 that results from a search using the name of an author from the author object 222 may be used to identify matched accounts 244, which may include a subset of identified authors. Further, content created, shared and/or commented on by the subset of identified authors may be extracted and merged at block 246.

At block 248, content generated via block 246 may be ranked. As described more fully below, in some embodiments, the content may be ranked based on information received via end-user 250 and/or author object 222.

At block 252, an output, which may include a list of content according to rank, may be generated.

Modifications, additions, or omissions may be made to the flow 200 without departing from the scope of the present disclosure. For example, the operations of flow 200 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments. In short, flow 200 is merely one example of data flow for identifying, extracting, and ranking information and the present disclosure is not limited to such.

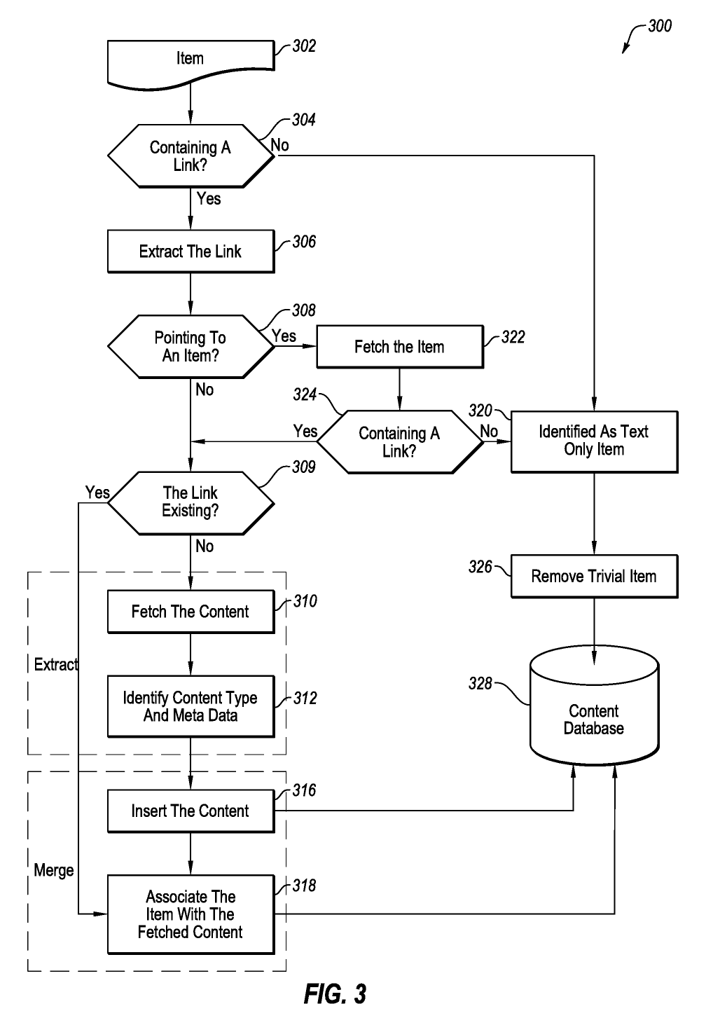

FIG. 3 shows an example flow diagram of a method 300 of extracting and merging content, arranged in accordance with at least one embodiment described herein. Although illustrated as discrete blocks, various blocks may be divided into additional blocks, combined into fewer blocks, or eliminated, depending on the desired implementation.

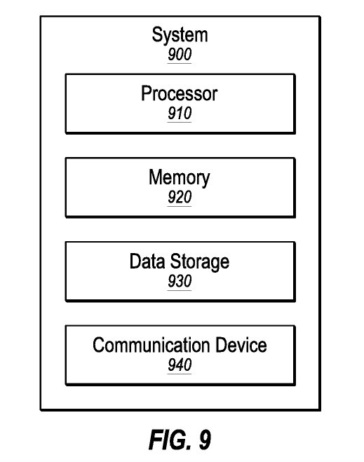

In some embodiments, method 300 may be performed by a system or device, such as system 900 of FIG. 9. For instance, processor 910 of system 900 (see FIG. 9) may be configured to execute computer instructions stored on memory 920 to perform functions and operations as represented by one or more of the blocks of method 300.

Method 300 may begin at block 302. At block 302, an item may be collected, and method 300 may proceed to block 304. For example, a social media content item, such as a tweet or a post may be collected.

At block 304, a determination may be made as to whether the item includes a link (e.g., selectable connection from one word, picture, or information object to another). If it is determined that the item includes a link, method 300 may proceed to block 306. If it is determined that the item does not include a link, method 300 may proceed to block 320.

At block 306, the link may be extracted, and method may proceed to block 308. At block 308, a determination may be made as to whether the extracted link is pointing to another item. For example, it may be determined whether the extracted link is pointing to another social media item, such as a tweet or a post. If it is determined that the extracted link is pointing to another item, method 300 may proceed to block 322. If it is determined that the extracted link is not pointing to another item, method 300 may proceed to block 309.

At block 309, a determination may be made as to whether a link exists in the current content database. If it is determined that a link exists, method 300 may proceed to block 318. If it is determined that a link does not exist, method 300 may proceed to block 310.

At block 310, content may be fetched, and method 300 may proceed to block 312. For example, the social media content of the item may be fetched. At block 312, content type and metadata may be identified, and method 300 may proceed to block 316.

At block 316, the content may be inserted in a content database 328, and method may proceed to block 318. At block 318, the item may be associated with the fetched content, and the content may be inserted in content database 328.

At block 322, the item may be fetched, and method 300 may proceed to block 324. At block 324, a determination may be made as to whether the item includes a link. If it is determined that the item includes a link, method 300 may proceed to block 310. If it is determined that the item does not include a link, method 300 may proceed to block 320. At block 320, the item may be identified as a text only item, and method 300 may proceed to block 326.

At block 326, irrelevant items may be discarded, and the content may be inserted in content database 328. For example, irrelevant items, such as a short, irrelevant message or Internet slang (e.g., LOL, OMG, etc.) may be discarded.

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment

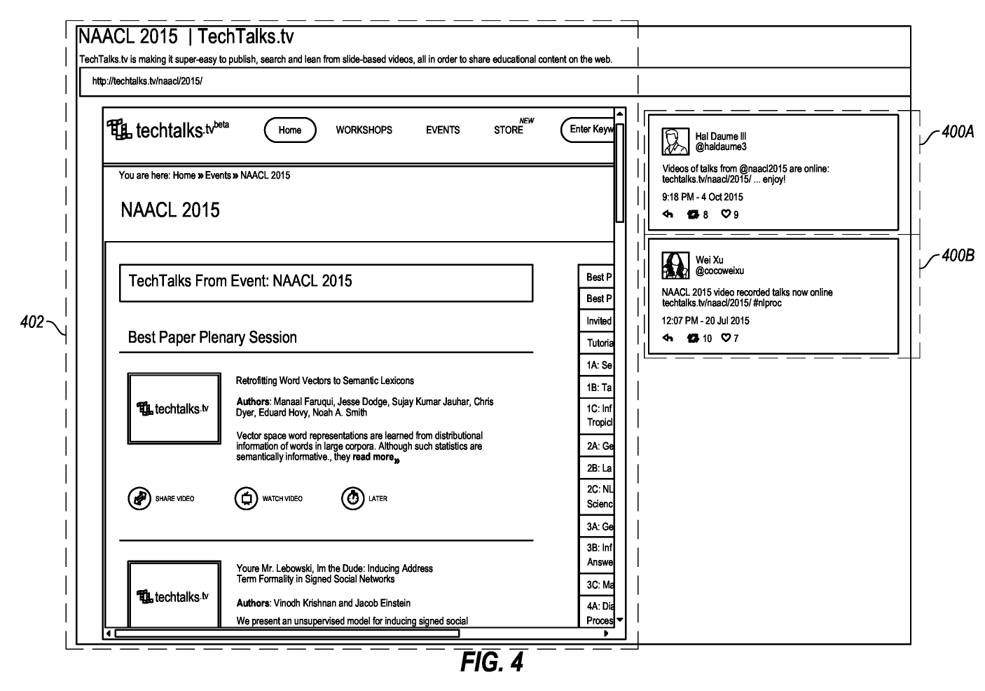

FIG. 4 depicts an example items 400A and 400B (e.g., tweets) and fetched content 402, which is associated with items 400A and 400B. More specifically, each item 400A and 400B include a link to content 402. Further, each item 400 may display a number of actions, such as “likes” and/or “retweets.”

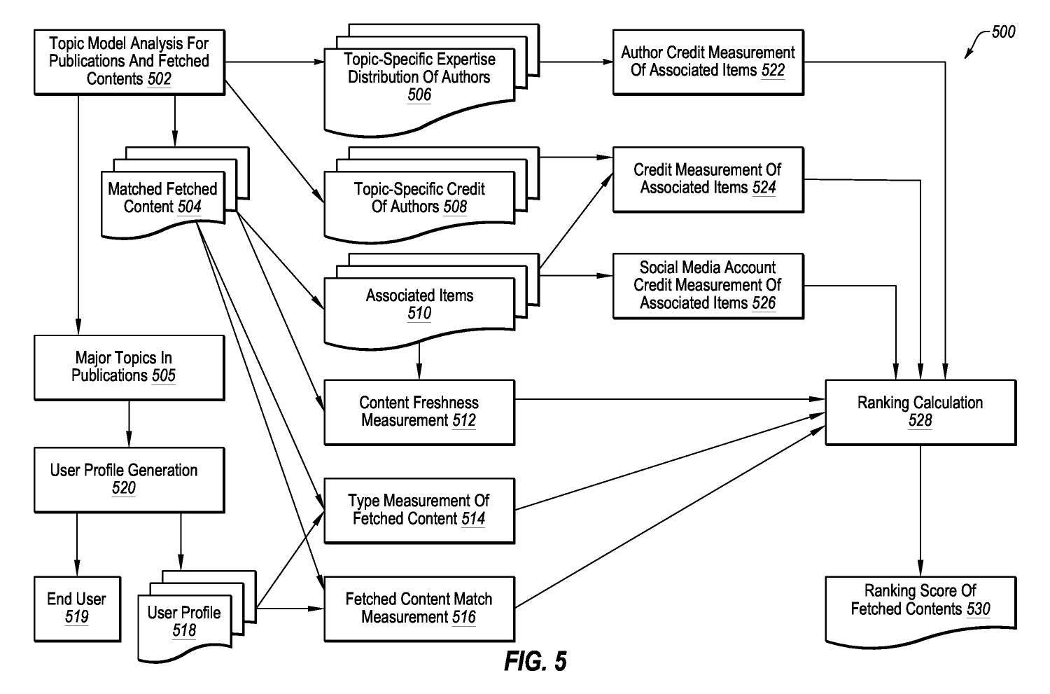

According to various embodiments, various measurement of fetched content (e.g., content 402) may be used to rank fetched content (e.g., one by one). For example, one or more associated items may be identified and a social media account, which posted the one or more items may be identified. This information may be used to calculate a social media account credit measurement of associated items, as described below with reference to block 526 in FIG. 5. Further, a real author, who owns the social media account may be identified, and may be used to calculate an author credit measurement of associated items, as described below with reference to block 522 in FIG. 5. In addition, statistical information related to the one or more items may be determined, and may be used to calculate a credit measurement of associated items, as described below with reference to block 524 of FIG. 5.

FIG. 5 is a diagram of an example flow 500 that may be used for ranking content fetched from social media, according to at least one embodiment described herein. In some embodiments, flow 500 may be configured to illustrate a process to rank content fetched from social media. In these and other embodiments, a portion of flow 500 may be an example of the operation of system 100 of FIG. 1.

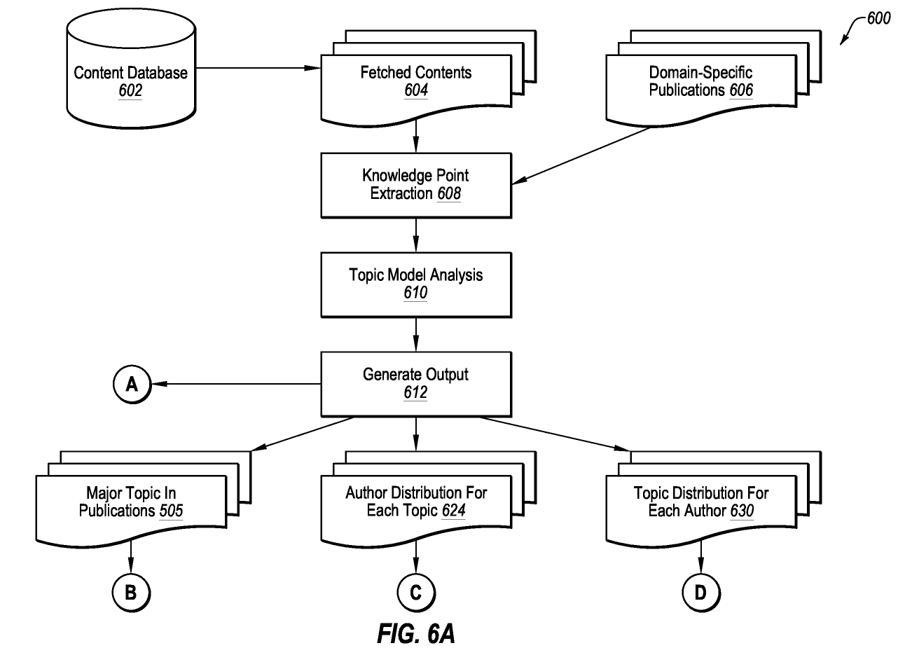

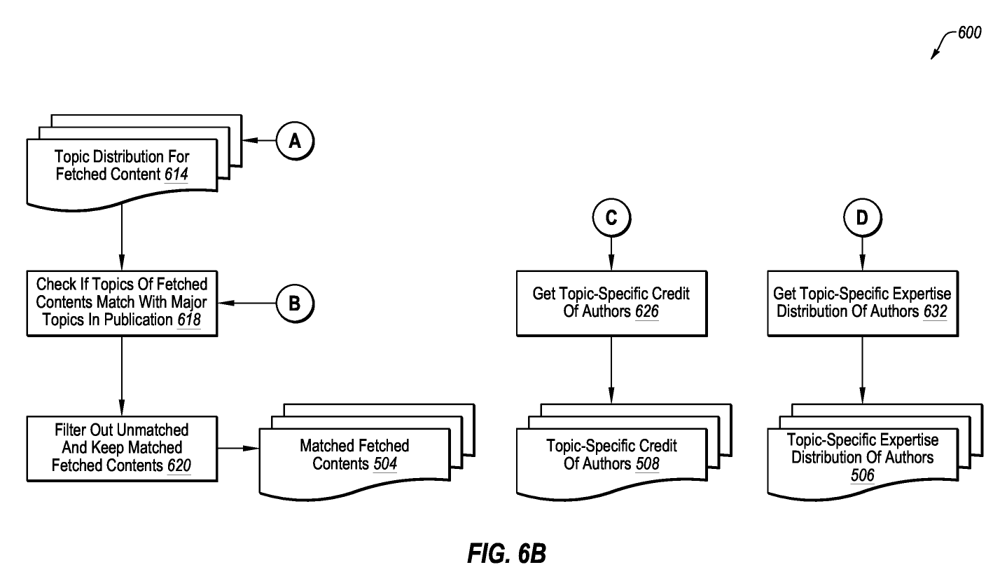

Flow 500 may begin at block 502, wherein a topic model analysis for publications and fetched content may be performed. The topic model analysis may generate matched fetched content 504, major topics in publications 505, topic-specific expertise distribution of authors 506, and topic-specific credit of authors 508. A topic model analysis will be described more fully below with reference to FIGS. 6A and 6B.

Fetched content 504 may be linked from associated items 510. Further, fetched content 504 may be used in various measurements, such as a content freshness measurement 512, a type measurement of fetched content 514, a fetched content match measurement 516.

As described more fully below, topic-specific expertise distribution of authors 506 and topic-specific credit of authors 508 may be used in an author credit measurement of associated items at block 522. Further, as described more fully below, associated items 510 may be used in author credit measurement of associated items at block 522, credit measurement of associated items at block 524 and a social media account credit measurement of associated items at block 526.

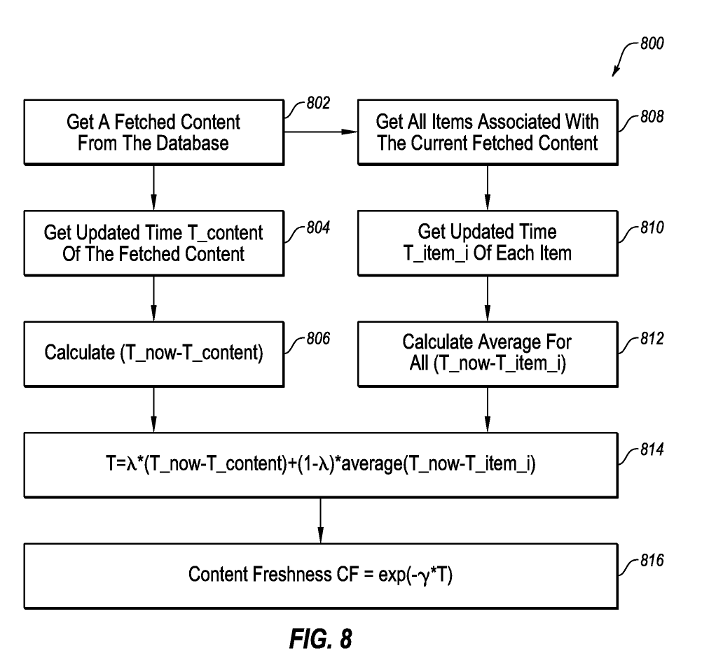

At block 512, a content freshness measurement to generate content age data may be performed based on fetched content 504 and corresponding associated items 510. In one embodiment, the content age data may comprise a content freshness score, which may be based on an age of the fetched social media content 504, an age of one or more associated items 510 (e.g., tweets, posts, etc.), or a combination thereof. For example, the content freshness measurement may be carried out according to a method 800 described below with reference to FIG. 8.

At block 514, a type measurement of fetched content to determine a type score of content 504 fetched from social media. For example, the social media content type score may be based on user defined type preferences (e.g., as defined in user profile 518) for content type (e.g., articles, papers, slides, videos, pictures, audio, etc.). More specifically, for example, a user may assign weights to content types, and these assigned weights may be used in determining the social media content type score. For example, a user (e.g., end user 519) may prefer videos over other content, thus, in this example, videos may be assigned a weight that is greater than weights assigned to other content.

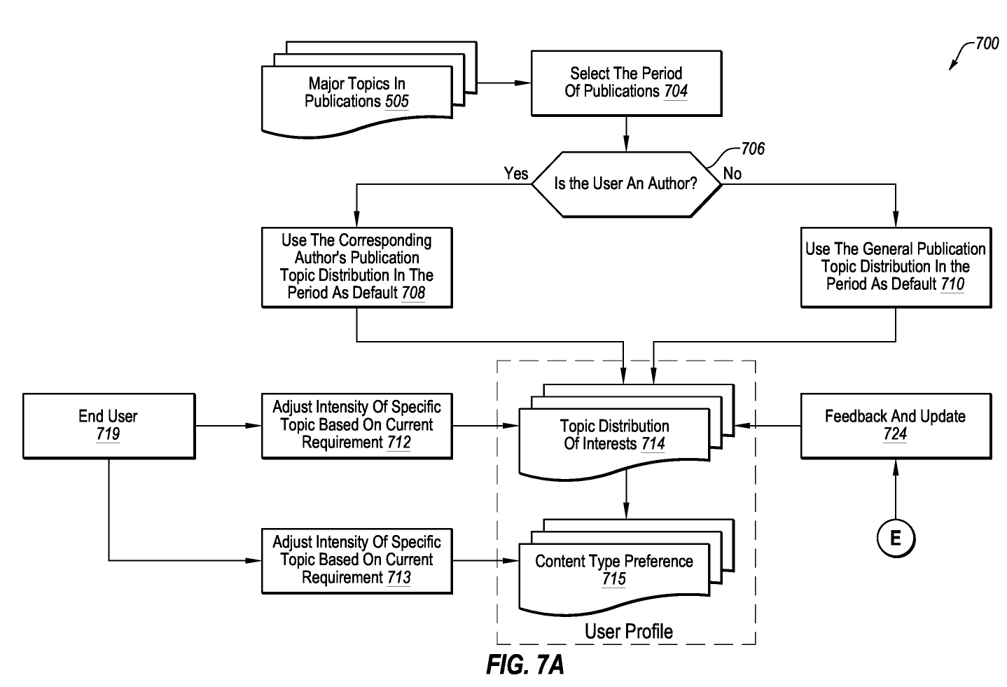

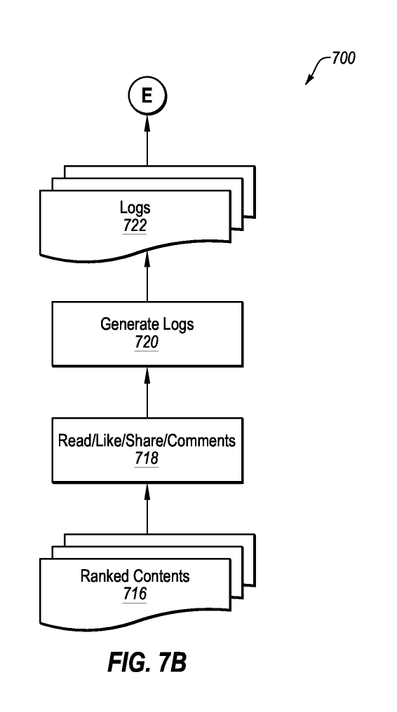

At block 520, a user profile 518 may be generated based on major topics in publications 505 and data from end user 519. For example, the user profile may be generated according to a flow 700 described below with reference to FIGS. 7A and 7B.

At block 516, a fetched content match measurement to determine a match score of content fetched from social media may be performed. The fetched content match measurement, which may be based on user profile 518 and fetched content 504, may include comparing a topic distribution of fetched content 504 and user interest data (e.g., as defined user profile 518), which may include an interest topic distribution of end user 519. For example, the fetched content match measurement may determine a match between topic distributions of the fetched content and an interest topic distribution of a user. More specifically, for example, a measure of the difference between two probability distributions (e.g., Kullback-Leibler divergence) may be determined.

At block 522, an author credit measurement of associated items may be performed. After identifying and matching a real author who owns a social media account including a posted item associated with the current fetched content, various scores may be calculated. For example, a network score for each author based on, for example, a citation network and a co-author network in publications may be calculated using one or more methods, such as a PageRank and betweeness centrality. In addition, a consistency score for each author may be calculated. As an example, topic-specific expertise distribution of author 508 and topic-specific credit of author 506 (which may be determined as described below in flow 600 with reference to FIGS. 6A and 6B) may be mixed by calculating a dot product to identify an enhanced topic-specific expertise distribution of author. Furthermore, we can calculate Kullback-Leibler divergence between the enhanced topic-specific expertise distribution of author and topic distribution of user interest 714 to generate the consistency score.

In one embodiment, the author credit score of an item associated with the current fetched content may be a linear combination of two or more factors such as the network score and the consistency score based on the author matched to the social media account posting the item. In addition, the average author credit score of all items associated with the current fetched content may be calculated.

At block 524, a credit measurement based on associated items 510 may be performed. For example, statistics of the items associated to the current fetched content, such as, a number of reposts, a number of likes and/or bookmarks, and/or a number of views of associated items may be used in the credit measurement to determine the social media item credit score. Further, weights, which may be assigned to one or more actions, such that one action (e.g., a repost) may have a higher value than another action (e.g., a view), may be considered in determining the social media item credit score. In one embodiment, the social media item credit score may be a linear combination of two or more statistics related to the actions. Further, an average credit of all items associated with the current fetched content may be calculated.

At block 526, a social media account credit measurement based on associated items 510 may be performed using statistics of a social media account that posted the associated item. Statistics for the social media account may include a social media account credit score, which may be based on various factors associated with the social media account. For example, the social media account credit score may be based on a social network analysis including a number of followers of the social media account, a number of times the social media account has been included in public lists, and/or a page rank of the social media account. Further, if the user (e.g., end user 519) also has a social media account, the following may be considered in determining the social media account credit score: 1) whether the user has a social connection with the social account (e.g., via social media); and 2) whether the user has ever interacted with the social media account (e.g., via social media), such as the social media account was mentioned by the user in social media.

In one embodiment, the social media account credit score may be a linear combination of two or more factors associated with the fetched content. Further, an average social media credit of all items associated with the current fetched content may be calculated.

At block 528, a ranking calculation may be performed to rank each fetched content from social media. For example, the ranking may be based on one or more factors, such as user interest data (e.g., in relation to topic distribution of interests), user preference data (e.g., in relation to preferred types of content), statistics for the associated items of the fetched content (e.g., a number of reposts of an item, a number of likes for the item, a number of views of the item, a number of times the item is bookmarked, etc.), author data (e.g. including citation networks and co-author networks, the author's interest and/or expertise in a topic), statistics for a social media account posting associated items (e.g., a number of followers of the social media account, a number of times the social media account has been included in public lists, and/or a PageRank of the social media account, whether the user has connected or ever interacted with the social media account, whether the social media account is mentioned in other items, etc.), content age data (e.g., content freshness), or any combination thereof.

In one embodiment, the ranking may be based on a linear combination of a content match score for the social media content, content type score for the social media content, a content freshness score for the social media content, a credit score for an author of the social media content, an item credit score for the social media content, and an account credit score for the social media content. In some embodiments, each of the scores may be weighted (e.g., as defined by the user). Further, the ranking calculation may be based on ad-hoc heuristic rules or statistical machine learning such as logistic regression with feedback from reading history logs

At block 530, ranking scores of fetched content 530 may be generated.

Modifications, additions, or omissions may be made to flow 500 without departing from the scope of the present disclosure. For example, the operations of flow 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIGS. 6A and 6B depict a diagram of an example flow 600 that may be used for performing a topic model analysis, according to at least one embodiment described herein. In some embodiments, flow 600 may be configured to illustrate a process to analyze topic models for publications and fetched content from social media. In these and other embodiments, a portion of flow 600 may be an example of the operation of system 100 of FIG. 1.

Flow 600 may begin at block 608, wherein a knowledge point extraction may be performed, and flow 600 may proceed to block 610. For example, the knowledge point extraction may be based on domain-specific publications 606 and fetched contents 604, which may be fetched from content database 602. Knowledge point extraction may include identifying knowledge points for each electronic document in a set. A phrase (i.e., more than one word) may be identified as a knowledge point and each identified knowledge point phrase may be treated as single unit (“word”). Knowledge point extraction may include any of the techniques described in U.S. patent application Ser. No. 14/796,838, entitled “Extraction of Knowledge Points and Relations From Learning Materials,” filed on Jul. 10, 2015, the contents of which are incorporated by reference.

At block 610, topic model analysis may be performed, and flow 600 may proceed to block 612. For example, in one embodiment, a specific number (predetermined by human or auto-selected by algorithms) of topics from all documents in the set of electronic documents may be identified. Further, a representation of each topic discovered in the set of electronic documents may be generated. The set of electronic documents may be organized by topic. Thus, phrases or words that were extracted may be treated as a basic unit. In some embodiments, the representation of each topic may be determined in terms of a probability distribution over all vocabulary in the set of electronic documents, where vocabulary may refer to all single words and knowledge point phrases. A probability distribution over all vocabulary may be illustrated as a list of vocabulary and with their corresponding frequency.

At block 612, outputs, including a topic distribution for fetched content 614, major topics in publications 505, an author distribution for each topic 624, and a topic distribution for each author 630, may be generated (e.g., via the topic model analysis).

The publication “Learning Author-Topic Models From Text Corpora,” M. Rosen-Zvi et al., ACM Transactions on Information Systems, Vol. 28, No. 1, Article 4, January 2010; available at https://cocosci.berkeley.edu/tom/papers/AT_tois.pdf [last accessed Aug. 8, 2016], depicts an example author distribution for each topic (see FIG. 1; 4:3) and an example topic distribution for each author (see FIG. 2, 4:4).

At block 618, it may be determined whether the topics of fetched content matches with the major topics in the publications, and flow 600 may proceed to block 620. For example, the topics of the fetched content and the major topics of the publications may be compared.

At block 620, unmatched fetched content may be filtered out, and matched fetched content 504 may be maintained. For example, if the majority of the publication topics are related to a specific topic (e.g., machine learning), and some fetched content concerns, for example, entertainment and/or politics, this content may be unrelated to the major publication topics, and thus the unrelated fetched content may be discarded.

At block 626, topic-specific credit of authors 508 may be retrieved based on author distribution of each topic 624. Further, at block 632, topic-specific expertise distribution of authors 506 may be retrieved based on topic distribution for each author 630.

Modifications, additions, or omissions may be made to flow 600 without departing from the scope of the present disclosure. For example, the operations of flow 600 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIGS. 7A and 7B show an example flow diagram of a flow 700 of generating a user profile, arranged in accordance with at least one embodiment described herein. Although illustrated as discrete blocks, various blocks may be divided into additional blocks, combined into fewer blocks, or eliminated, depending on the desired implementation.

In some embodiments, flow 700 may be performed by a system or device, such as system 900 of FIG. 9. For instance, processor 910 of system 900 (see FIG. 9) may be configured to execute computer instructions stored on memory 920 to perform functions and operations as represented by one or more of the blocks of flow 700.

At block 704, a time period for major topics in publications 505 may be selected, and flow 700 may proceed to block 706. At block 706, a determination may be made as to whether the user is an author. If it is determined that the user is an author, flow 700 may proceed to block 708. If it is determined that the user is not an author, flow 700 may proceed to block 710.

At block 708, the corresponding author's publication topic distribution in the selected time period may be used as default. At block 710, a general publication topic distribution in the selected time period may be used as the default.

At block 712, an intensity of a specific topic may be adjusted based on a current requirement. For example, if end user 719 wishes to adjust his/her topics of interest, end user 719 may adjust the intensity. More specifically, for example, if the user has been interested in one topic (e.g., machine learning), but now wants to receive more information on a second topic (e.g., cancer treatment), the user make adjustment to receive more information on the second topic.

Further, at block 713, content type preference 715 may be set (e.g., by end user 719).

At block 718, ranked contents 716 (e.g., previously ranked social media content) may be read, liked, shared, and/or commented on, and flow 700 may proceed to block 720. At block 720, one or more logs 722 may be generated. For example, logs related to the user's behaviors (e.g., what the user has read, liked, commented on, shared, etc.) may be generated.

Further, topic distribution of interests 714 may be generated based on one or more of blocks 708, 710, and 712. Further, topic distribution of interest 714 may be updated, via block 724, based on, for example, a user's actions (e.g., “shares,” “reads,” “likes”, “retweets,” etc.) recorded in one or more social media usage logs. Further, actions (e.g., “shares,” “reads,” “likes,” “retweets,” etc.) may be assigned different weights for updating topic distribution of interest 714. More specifically, for example, a “like” or a “share” may be given a different (e.g., higher) weight than a “read.”

Modifications, additions, or omissions may be made to flow 700 without departing from the scope of the present disclosure. For example, the operations of flow 800 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 8 shows an example flow diagram of a method 800 of measuring content freshness, arranged in accordance with at least one embodiment described herein. Although illustrated as discrete blocks, various blocks may be divided into additional blocks, combined into fewer blocks, or eliminated, depending on the desired implementation.

In some embodiments, method 800 may be performed by a system or device, such as system 900 of FIG. 9. For instance, processor 910 of system 900 (see FIG. 9) may be configured to execute computer instructions stored on memory 920 to perform functions and operations as represented by one or more of the blocks of method 800.

Method 800 may begin at block 802. At block 802, fetched content (e.g., from a database) may be retrieved, and method 800 may proceed to block 804 and block 808. At block 804, a time T_content associated with the fetched content may be determined, and method 800 may proceed to block 806. At block 806, an age of the fetched content may be calculated, and method 800 may proceed to block 814. For example, time T_content may be subtracted from the current time T_now (e.g., T_now−T_content) to determine the age of the fetched content.

At block 808, items (e.g., tweets, posts, etc.) associated with the fetched content may be retrieved, and method 800 may proceed to block 810. At block 810, a time T_item_i associated with each item may be determined, and method 800 may proceed to block 812. At block 812, an average age for all items may be calculated, and method 800 may proceed to block 814. For example, time T_item_i for each item may be subtracted from the current time T_now (e.g., T_now−T_item_i) to determine the age of each item, and an average age of all items may be calculated.

At block 814, an average age of the fetched content and all associated items may be calculated, and method 800 may proceed to block 816. For example only, the average age of the fetched content and all associated items may be calculated according to the following equation: T=λ*(T_now−T_content)+(1−λ)*average(T_now−T_item_1); wherein λ is a constant and 0<λ<1.

At block 816, content freshness CF may be calculated. For example only, content freshness may be calculated according to the following equation: CF=exp(−γ*T), wherein γ is a constant used to adjust impact of age.

FIG. 9 illustrates an example system 900, according to at least one embodiment described herein. System 900 may include any suitable system, apparatus, or device configured to test software. System 900 may include a processor 910, a memory 920, a data storage 930, and a communication device 940, which all may be communicatively coupled. Data storage 930 may include various types of data, such as author objects and social media account objects.

Generally, processor 910 may include any suitable special-purpose or general-purpose computer, computing entity, or processing device including various computer hardware or software modules and may be configured to execute instructions stored on any applicable computer-readable storage media. For example, processor 910 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 9, it is understood that processor 910 may include any number of processors distributed across any number of network or physical locations that are configured to perform individually or collectively any number of operations described herein. In some embodiments, processor 910 may interpret and/or execute program instructions and/or process data stored in memory 920, data storage 930, or memory 920 and data storage 930. In some embodiments, processor 910 may fetch program instructions from data storage 930 and load the program instructions into memory 920.

After the program instructions are loaded into memory 920, processor 910 may execute the program instructions, such as instructions to perform flow 200, flow 500, flow 600, flow 700, method 300, and/or method 800 as described herein. For example, processor 910 may create the author objects and the social media account objects using information from publication systems and social media systems, respectively. Processor 910 may compare the information from the author objects and the social media account objects to identify social media accounts associated with authors from the author objects.

Memory 920 and data storage 930 may include computer-readable storage media or one or more computer-readable storage mediums for carrying or having computer-executable instructions or data structures stored thereon. Such computer-readable storage media may be any available media that may be accessed by a general-purpose or special-purpose computer, such as processor 910.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 910 to perform a certain operation or group of operations.

Communication unit 940 may include any component, device, system, or combination thereof that is configured to transmit or receive information over a network. In some embodiments, communication unit 940 may communicate with other devices at other locations, the same location, or even other components within the same system. For example, communication unit 940 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 940 may permit data to be exchanged with a network and/or any other devices or systems described in the present disclosure. For example, the communication unit 940 may allow system 900 to communicate with other systems, such as publication systems 120, social media systems 130, and device 140 of FIG. 1.

Modifications, additions, or omissions may be made to system 900 without departing from the scope of the present disclosure. For example, the data storage 930 may be multiple different storage mediums located in multiple locations and accessed by processor 910 through a network.

As indicated above, the embodiments described herein may include the use of a special purpose or general purpose computer (e.g., processor 910 of FIG. 9) including various computer hardware or software modules, as discussed in greater detail below. Further, as indicated above, embodiments described herein may be implemented using computer-readable media (e.g., memory 920 or data storage 930 of FIG. 9) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system, comprising:
one or more processors configured to:
extract author profile data from one or more authors of domain-specific content;
identify social media content based on the author profile data; and
rank the social media content based on at least one of user interest data, user preference data, statistics for the social media content, author data, statistics for a social media account including the social media content, and content age data.

2. The system of claim 1, wherein the user interest data includes a social media content match score based on a comparison of a topic distribution of the social media content and an interest topic distribution of a user.

3. The system of claim 1, wherein the user preference data comprises a social media content type score based on one or more a user-defined preferences for social media content types.

4. The system of claim 1, wherein the age data comprises a content freshness score based on at least one of an age of the social media content and an age of one or more items associated with the social media content.

5. The system of claim 1, wherein the author data comprises an author credit score based on at least one of a number of times the author is cited, a number of followers of the author, the author's interest in a topic, and the author's expertise in the topic.

6. The system of claim 1, wherein the statistics for the social media content comprises a social media item credit score based on a measurement of at least one of a number of reposts for an item associated with the social media content, a number of likes for the item, a number of views of the item, and a number of bookmarks for the item.

7. The system of claim 1, wherein the statistics for a social media account comprises an account credit score based on a measurement of number of followers of a social media account, a number of listings of the social media account, and a rank of the social media account.

8. The system of claim 1, wherein the social media content is ranked based on a linear combination of two or more of the user interest data, the user preference data, the statistics for the social media content, the author data, the statistics for a social media account including the social media content, and the content age data.

9. A non-transitory computer-readable media having computer instructions stored thereon that are executable by a processing device to perform or control performance of operations comprising:
extracting author profile data from one or more authors of domain-specific content;
identifying social media content based on the author profile data; and
ranking the social media content based on at least one of user interest data, user preference data, statistics for the social media content, author data, statistics for a social media account including the social media content, and content age data.

10. The non-transitory computer-readable media of claim 9, wherein ranking the social media content based on user interest data includes determining a social media content match score based on a comparison of a topic distribution of the social media content and an interest topic distribution of a user.

11. The non-transitory computer-readable media of claim 9, wherein ranking the social media content based on user preference data comprises determining a social media content type score based on one or more a user-defined preferences for social media content types.

12. The non-transitory computer-readable media of claim 9, wherein ranking the social media content based on author data comprises determining an author credit score based on at least one of a number of times the author is cited, a number of followers of the author, the author's interest in a topic, and the author's expertise in the topic.

13. The non-transitory computer-readable media of claim 9, wherein ranking the social media content based on the statistics for the social media content comprises determining a social media item credit score based on a measurement of at least one of a number of reposts for an item associated with the social media content, a number of likes for the item, a number of views of the item, and a number of bookmarks for the item.

14. The non-transitory computer-readable media of claim 9, wherein ranking the social media content based on statistics for a social media account comprises determining an account credit score based on a measurement of number of followers of a social media account, a number of listings of the social media account, and a rank of the social media account.

15. A method of ranking social media content, comprising:
extracting author profile data from one or more authors of domain-specific content;
identifying social media content based on the author profile data; and
ranking the social media content based on at least one of user interest data, user preference data, statistics for the social media content, author data, statistics for a social media account including the social media content, and content age data.

16. The method of claim 15, wherein ranking the social media content based on user interest data includes determining a social media content match score based on a comparison of a topic distribution of the social media content and an interest topic distribution of a user.

17. The method of claim 15, wherein ranking the social media content based on user preference data comprises determining a social media content type score based on one or more a user-defined preferences for social media content types.

18. The method of claim 15, wherein ranking the social media content based on reputation data comprises determining an author credit score based on at least one of a number of times the author is cited, a number of followers of the author, the author's interest in a topic, and the author's expertise in the topic.

19. The method of claim 15, wherein ranking the social media content based on age data comprises determining a content freshness score based on at least one of an age of the social media content and an age of one or more items associated with the social media content.
